(19) United States
(12) Patent Application Publication
(10) Pub. No.: US 2025/0266510 A1
(43) Pub. Date: Aug. 21, 2025

(54) WIRELESS BATTERY MANAGEMENT DEVICE, BATTERY PACK INCLUDING THE SAME, AND DEVICE INCLUDING THE BATTERY PACK

(71) Applicant: SK ON CO., LTD., Seoul (KR)

(72) Inventors: Ho Sang JANG, Daejeon (KR); Jin Young AN, Daejeon (KR)

(21) Appl. No.: 19/025,250

(22) Filed: Jan. 16, 2025

(30) Foreign Application Priority Data
Feb. 19, 2024 (KR) 10-2024-0023569

(51) Int. Cl. H01M 10/42; B60L 58/10; H01M 50/204

(52) U.S. Cl. CPC H01M 10/425; H01M 50/204; B60L 58/10; H01M 2010/4271; H01M 2010/4278; H01M 2220/20

(57) ABSTRACT

A wireless battery management device includes: a first battery management module located inside a first case which houses battery modules, and configured to comprehensively manage the battery modules; a first wireless communication chip located inside the first case, and connected to the first battery management module; second battery management modules respectively located inside second cases formed including a metal material, each of which houses the battery modules, and configured to monitor and manage states of the battery modules, respectively; and second wireless communication chips respectively located inside the second cases, each of which is connected to the second battery management modules, and configured to communicate wirelessly with the first wireless communication chip, wherein the second cases include first openings formed respectively at positions facing the second wireless communication chips.

### CROSS-REFERENCE TO RELATED APPLICATION AND CLAIM OF PRIORITY

This application claims priority to Korean Patent Application No. 10-2024-0023569 filed on Feb. 19, 2024 in the Korean Intellectual Property Office (KIPO), the entire disclosure of which is incorporated by reference herein.

### BACKGROUND OF THE INVENTION

### 1. Field of the Invention

The present disclosure relates to a wireless battery management device, a battery pack including the same, and a device including the battery pack.

### 2. Description of the Related Art

A secondary battery is a battery that can be repeatedly charged and discharged. With rapid progress of information and communication, and display industries, the secondary battery has been widely applied to various portable electronic telecommunication devices such as a camcorder, a mobile phone, a tablet personal computer (PC), a laptop PC, etc. as a power source thereof. Recently, a battery pack including a plurality of battery modules has been developed as a power source of an eco-friendly automobile such as an electric vehicle.

Meanwhile, the battery pack may include a battery management system (BMS) for monitoring and managing states of battery modules. The battery management system may include slave BMSs located in each battery module and a master BMS which is connected to each slave BMS and comprehensively manages a plurality of battery modules. With the development of wireless communication technique, the slave BMS and the master BMS are connected wirelessly with each other. However, since the battery module is surrounded by a metal case (e.g., aluminum foil), the slave BMS should be located outside the battery module for wireless communication with the master BMS. Alternately, even if the slave BMS is located inside the battery module, an antenna (e.g., a wire-type antenna) should be located outside the battery module. As such, since an additional space for installing the slave BMS or the antenna is required, there is a problem that a volume of installing the battery pack is increased, or it is difficult to increase an energy density of the battery pack.

### SUMMARY OF THE INVENTION

According to an aspect of the present disclosure, it is an object to provide a wireless battery management device which may have improved space efficiency, a battery pack including the same, and a device including the battery pack.

According to another aspect of the present disclosure, it is an object to provide a wireless battery management device which may have improved manufacturing efficiency, a battery pack including the same, and a device including the battery pack.

The wireless battery management device of the present disclosure and/or the battery pack including the same may be widely applied in green technology fields, such as electric vehicles, battery charging stations, as well as solar power generation, wind power generation, and the like, which use the batteries. In addition, the wireless battery management device of the present disclosure and/or the battery pack including the same may be used in eco-friendly electric vehicles, hybrid vehicles, and the like, which are intended to prevent climate change by suppressing air pollution and greenhouse gas emission.

To achieve the above objects, according to an aspect of the present invention, there is provided a wireless battery management device, including: a first battery management module located inside a first case which houses a plurality of battery modules, and configured to comprehensively manage the plurality of battery modules; a first wireless communication chip located inside the first case, and connected to the first battery management module; a plurality of second battery management modules respectively located inside a plurality of second cases formed including a metal material, each of which houses the plurality of battery modules, and configured to monitor and manage states of the plurality of battery modules, respectively; and a plurality of second wireless communication chips respectively located inside the plurality of second cases, each of which is connected to the plurality of second battery management modules, and configured to communicate wirelessly with the first wireless communication chip. The plurality of second cases may include first openings formed respectively at positions facing the plurality of second wireless communication chips.

According to an embodiment, the first case may include: a first region where the plurality of battery modules are located; and a second region where a first substrate, on which the first battery management module and the first wireless communication chip are mounted, is located.

According to an embodiment, the first region and the second region may be separated by a shielding film having a second opening formed on one side thereof.

According to an embodiment, the first case may include: a first region where some of the plurality of battery modules are located; a second region where the remainder of the plurality of battery modules are located; and a third region where a first substrate, on which the first battery management module and the first wireless communication chip are mounted, is located.

According to an embodiment, the first region, the second region, and the third region may be separated from each other by shielding films, and the shielding film may have a second-1 opening formed between the first region and the third region, and a second-2 opening formed between the second region and the third region.

According to an embodiment, the first wireless communication chip may be disposed at an end portion of the first substrate on which the first battery management module and the first wireless communication chip are mounted, and the plurality of second wireless communication chips may be respectively disposed at end portions of the plurality of second substrates.

According to an embodiment, the first wireless communication chip and the plurality of second wireless communication chips may include antennas configured to transmit and receive wireless signals.

According to an embodiment, the device may further include an external communication chip configured to communicate with an external device operated by a power received from a battery pack including the wireless battery management device.

According to another aspect of the present invention, there is provided a battery pack, including: a plurality of battery modules which include a plurality of battery cells, respectively; a first case which houses the plurality of battery modules; a first substrate which includes a first battery management module located on one side of an inside of the first case and configured to comprehensively manage the plurality of battery modules, and a first wireless communication chip connected to the first battery management module; a plurality of second substrates which include a second battery management module configured to monitor states of the plurality of battery cells, and a second wireless communication chip connected to the second battery management module and configured to communicate wirelessly with the first wireless communication chip, wherein the plurality of second substrates are included in the plurality of battery modules, respectively; and a plurality of second case which house the plurality of battery cells and the plurality of second substrates, has at least one opening formed at a position facing the second wireless communication chip, and is formed including a metal material.

In addition, according to another aspect of the present invention, there is provided a device including a battery pack including: a battery pack which includes the wireless battery management device according to the above-described embodiments; a communication module configured to communicate with the wireless battery management device; and a control system configured to communicate with the wireless battery management device through the communication module, and control a state of the battery pack.

According to an embodiment of the present disclosure, a space efficiency may be improved. For example, the present disclosure may dispose a wireless communication chip inside a module case (or a cell case) formed including a metal material which surrounds the battery module (or battery cells), and form a hole on one side of the module case (or the cell case) (e.g., at a position facing the wireless communication chip). Through this, the present disclosure may minimize an installation space of the wireless communication chip, thereby minimizing an increase in the volume of the battery pack (or the battery module), and increasing an energy density of the battery pack (or the battery module).

In addition, the present disclosure may prevent performance degradation of the wireless communication chip. For example, the present disclosure may prevent performance degradation of the wireless communication by disposing the wireless communication chip at an end portion of the substrate on which the wireless communication chip is mounted so as to be spaced apart from other components which may affect wireless communication.

In addition, the present disclosure may improve manufacturing efficiency. For example, there is no need to expose the antenna to the outside of the module case (or the cell case). As such, the present disclosure may facilitate manufacturing processes and reduce manufacturing costs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating the configuration of a battery pack according to an embodiment of the present disclosure;

FIG. 2A is a view illustrating a main substrate according to an embodiment of the present disclosure;

FIG. 2B is a view illustrating a sub substrate according to an embodiment of the present disclosure;

FIG. 3 is a view illustrating the configuration of a battery pack according to another embodiment of the present disclosure;

FIG. 4 is a view illustrating the configuration of a battery pack according to another embodiment of the present disclosure;

FIG. 5 is a view illustrating the configuration of a battery pack according to another embodiment of the present disclosure; and

FIG. 6 is a view illustrating an electric vehicle including the battery according to an embodiment of the present disclosure.

### DETAILED DESCRIPTION OF THE INVENTION

Hereinafter, the present disclosure will be described in detail through embodiments with reference to the accompanying drawings. However, the embodiments are merely illustrative and the present disclosure is not limited to the specific embodiments described by way of example.

Although a first, a second, and the like are used to describe various elements, components and/or sections, these elements, components and/or sections are of course not limited by these terms. These terms are merely used to distinguish one element, component and/or section from another element, component and/or section. Therefore, it goes without saying that the first element, first component or first section mentioned below may also be the second element, second component or second section within the technical spirit of the present disclosure.

Terms used herein are for the purpose of describing particular embodiments only and are not intended to limit the present disclosure thereto. As used herein, singular forms are intended to include the plural forms as well, unless the context clearly indicates otherwise. It will be further understood that the terms “comprises” and/or “made of,” as used herein, do not preclude the presence or addition of one or more components, steps, operations and/or elements other than those mentioned component, step, operation and/or element.

Unless otherwise defined, all terms (including technical and scientific terms) used herein have the same meaning as commonly understood by one of ordinary skill in the art to which the present disclosure pertains. Terms, such as those defined in commonly used dictionaries, are not to be construed in an idealized or overly formal sense unless expressly so defined herein.

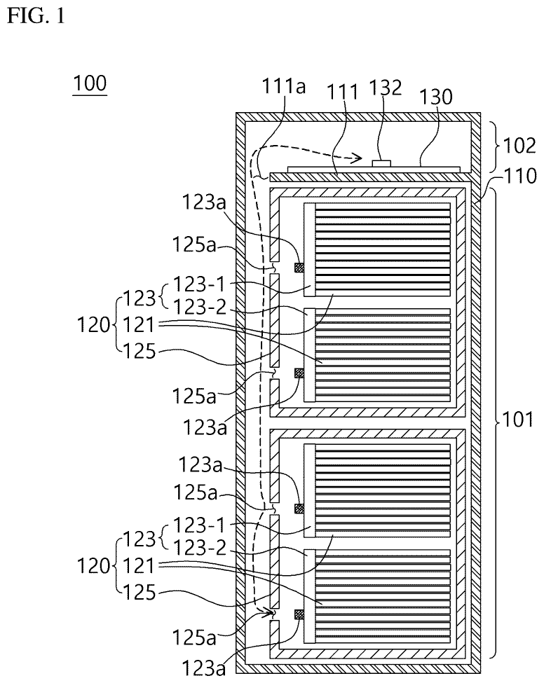

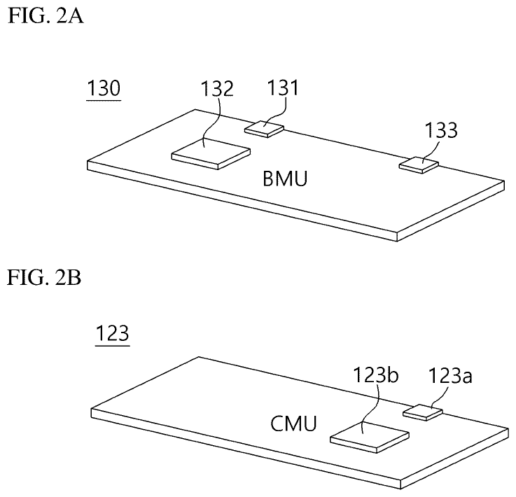

FIG. 1 is a view illustrating the configuration of a battery pack according to an embodiment of the present disclosure, FIG. 2A is a view illustrating a main substrate according to an embodiment of the present disclosure, and FIG. 2B is a view illustrating a sub substrate according to an embodiment of the present disclosure.

Referring to FIGS. 1 to 2B, a battery pack 100 according to an embodiment of the present disclosure may include a first case (hereinafter, referred to as a pack case) 110, a plurality of battery modules 120, and a first substrate (hereinafter, referred to as a main substrate) 130.

The main substrate 130 may be located inside the pack case 110. For example, the main substrate 130 may be located in a second region 102 separated from a first region 101 where the plurality of battery modules 120 are located. As shown in FIG. 2A, the main substrate 130 may include a first wireless communication chip 131, a first battery management module (hereinafter, referred to as a master battery management system) 132, and an external communication chip 133.

The first wireless communication chip 131 may communicate wirelessly with the plurality of battery modules 120 (e.g., second wireless communication chips 123a). The first wireless communication chip 131 may include a communication module (not shown) which converts a baseband signal into a wireless signal or converts the wireless signal into the baseband signal, and an antenna (e.g., a chip antenna) which transmits and receives the wireless signal. According to an embodiment, the antenna may not be included in the first wireless communication chip 131, but may also be mounted on the main substrate 130 as a separate configuration.

The first wireless communication chip 131 is located on one side of the inside of the pack case 110, and may be connected to the master battery management system 132. The first wireless communication chip 131 may be located at an end portion of the main substrate 130 so as to be spaced apart from other components (not shown) which may affect wireless communication, as shown in FIG. 2A. Through this, the present disclosure may minimize (or prevent) performance degradation of wireless communication between the first wireless communication chip 131 and the second wireless communication chip 123a. Meanwhile, the battery pack 100 may include a plurality of first wireless communication chips 131 (or a plurality of chip antennas). This is intended to improve a bandwidth, thereby enhancing a wireless communication speed.

The master battery management system 132 may perform an integrated management (e.g., state monitoring, charging control, and/or discharging control) of the plurality of battery modules 120. For example, the master battery management system 132 may receive state information from each battery module through the first wireless communication chip 131, and transmit control information for controlling the charging, discharging, and/or cell balancing to each battery module based on the received state information. The master battery management system 132 may be a battery management unit (BMU).

The external communication chip 133 may communicate with an external device (e.g., an electric mobility device, an energy storage system (ESS), etc.) that can be operated by a power received from the battery pack 100. For example, if the battery pack 100 is included in an electric vehicle, the external communication chip 133 may communicate with a control system (e.g., an electronic control unit (ECU)) of the electric vehicle. The external communication chip 133 may support a wired communication network (e.g., a control area network (CAN)) or a wireless communication network.

The plurality of battery modules 120 may be located inside the pack case 110. For example, the plurality of battery modules 120 may be located in the first region 101 of the pack case 110. Although not shown in the drawings, the plurality of battery modules 120 may be fixed to the pack case 110 through a fixing device (e.g., a tray).

Each of the plurality of battery modules 120 may include a plurality of stacked battery cells 121, at least one second substrate (hereinafter, referred to as a sub substrate) 123, and a second case (hereinafter, referred to as a module case) 125.

Each of the plurality of battery cells 121 is a minimum unit of a secondary battery, and may include a cathode material, an anode material, an electrolyte and the like.

At least one sub substrate 123 may be connected to at least some of the plurality of battery cells 121. For example, as shown in FIG. 1, at least one sub substrate 123 may include a first sub substrate 123-1 connected to some of the plurality of battery cells 121 and a second sub substrate 123-2 connected to the remaining some of the plurality of battery cells 121. Each of the sub substrates (e.g., the first sub substrate 123-1 and the second sub substrate 123-2) may include the second wireless communication chip 123a and a second battery management module (hereinafter, referred to as a slave battery management system) 123b, as shown in FIG. 2B. Meanwhile, although FIG. 1 illustrates the case where the at least one sub substrate 123 includes two sub substrates (the first sub substrate 123-1 and the second sub substrate 123-2) as an example, the at least one sub substrate 123 may include one or three or more sub substrates.

The second wireless communication chip 123a is located on one side of the inside of the module case 125, and may be connected to the slave battery management system 123b. The second wireless communication chip 123a may communicate wirelessly with the first wireless communication chip 131. For example, the second wireless communication chip 123a may transmit the state of the battery cell to the first wireless communication chip 131. In addition, the second wireless communication chip 123a may receive the control information from the first wireless communication chip 131. The second wireless communication chip 123a may include a communication module (not shown) and an antenna (e.g., a chip antenna). According to an embodiment, the antenna may not be included in the second wireless communication chip 123a, but may also be mounted on the sub substrate 123 as a separate configuration.

The second wireless communication chip 123a may be located at the end portion of the sub substrate 123 so as to be spaced apart from other components (not shown) which may affect wireless communication, as shown in FIG. 2B. Through this, the present disclosure may minimize (or prevent) the performance degradation of wireless communication between the second wireless communication chip 123a and the first wireless communication chip 131.

The slave battery management system 123b may monitor and manage the state of the battery cell. For example, the slave battery management system 123b may transmit the state of the monitored battery cell to the first wireless communication chip 131 through the second wireless communication chip 123a. In addition, the slave battery management system 123b may control the charging, discharging, and/or cell balancing of the battery cell according to control information received through the second wireless communication chip 123a. The slave battery management system 123b may be a cell monitoring unit (CMU).

The module case 125 may house the plurality of battery cells 121 and at least one sub substrate 123. The module case 125 may be formed including a metal material. The module case 125 may have a first opening (or, first hole) 125a formed at a position facing the second wireless communication chip 123a.

The pack case 110 may house the plurality of battery modules 120 and the main substrate 130. The pack case 110 may be formed including a metal material (e.g., aluminum), or may be formed of a non-metallic material.

According to an embodiment, the pack case 110 may include the first region 101 where the plurality of battery modules 120 are located and the second region 102 where the main substrate 130 is located. The first region 101 and the second region 102 may be separated by a shielding film 111. The shielding film 111 may have a second opening (hereinafter, referred to as a second hole) 111a formed on one side thereof. The second hole 111a may provide a wireless communication path between the first wireless communication chip 131 and the second wireless communication chip 123a.

Meanwhile, the battery pack 100 according to an embodiment of the present disclosure may not include some of the above-described configurations, or may further include at least one other configuration (e.g., an ECM estimation module, an EIS measurement module, a temperature sensor, etc.). In addition, although the case where the battery modules are arranged in a longitudinal direction (or a vertical direction) is shown in FIG. 1, the battery modules may be arranged in a transverse direction (or a horizontal direction).

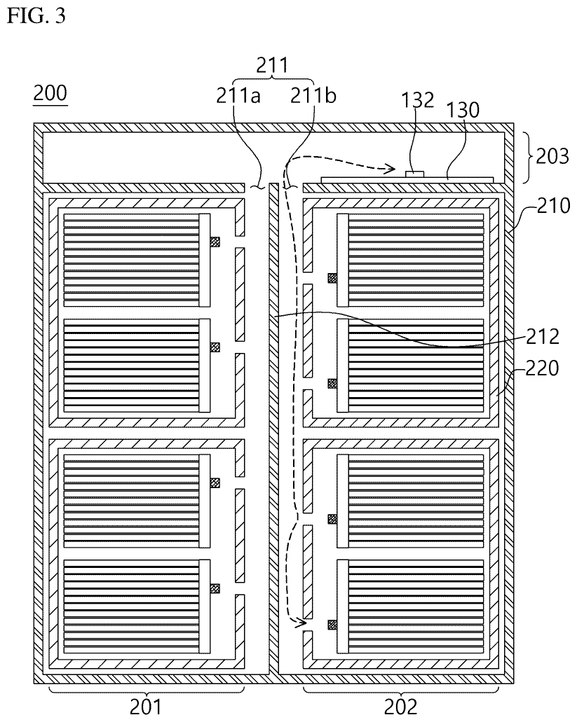

FIG. 3 is a view illustrating the configuration of a battery pack according to another embodiment of the present disclosure.

Referring to FIG. 3, a battery pack 200 according to another embodiment of the present disclosure may be similar to the battery pack 100 of FIG. 1. The battery pack 200 may include a plurality of battery modules 220 arranged in a plurality of rows within a pack case 210. To this end, the pack case 210 may include a first region 201 where some of the plurality of battery modules 220 are located, a second region 202 where the remainder of the plurality of battery modules 220 are located, and a third region 203 where the main substrate 130 is located. The first region 201 to the third region 203 may be separated by a first shielding film 211 and a second shielding film 212. The first shielding film 211 may have a second-1 opening (or a second-1 hole) 211a formed between the first region 201 and the third region 203, and a second-2 opening (or a second-2 hole) 211b formed between the second region 202 and the third region 203.

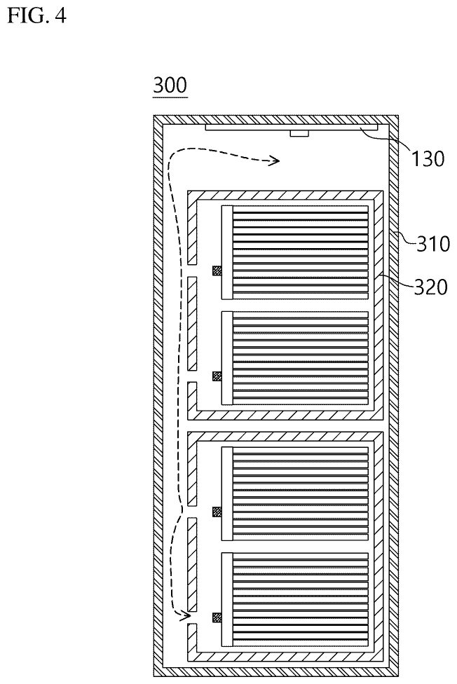

FIG. 4 is a view illustrating the configuration of a battery pack according to another embodiment of the present disclosure.

Referring to FIG. 4, in a battery pack 300 according to another embodiment of the present disclosure, a pack case 310 may not be separated into a region where a main substrate 130 is disposed and a region where battery modules 320 are disposed. At this time, the main substrate 130 may be disposed on an inner surface of the pack case 310. Thereby, the battery pack 300 according to another embodiment of the present disclosure may have a further reduced volume compared to the battery pack 100 of FIG. 1.

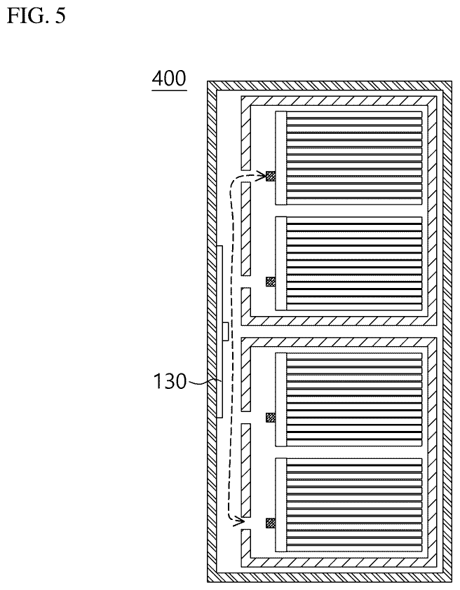

FIG. 5 is a view illustrating the configuration of a battery pack according to another embodiment of the present disclosure.

Referring to FIG. 5, a battery pack 400 according to another embodiment of the present disclosure is similar to the battery pack 300 of FIG. 4, except that the location of the main substrate 130 is different. That is, the volume of the battery pack 400 may be further reduced compared to the battery pack 100 of FIG. 1.

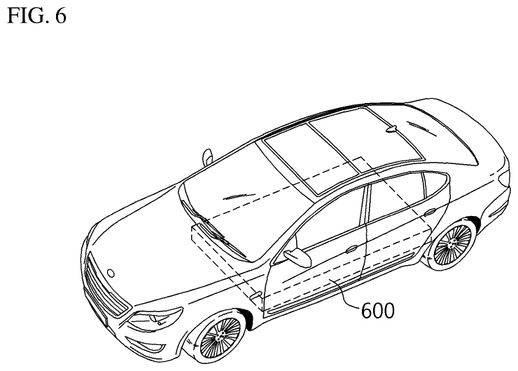

FIG. 6 is a view illustrating an electric vehicle including the battery according to an embodiment of the present disclosure.

Referring to FIG. 6, the electric vehicle according to an embodiment of the present disclosure may be driven by a power received from the battery. For example, the electric vehicle may receive the power required to drive an electric motor from a battery 600. The battery 600 may be battery packs 100, 200, 300 and 400 of FIGS. 1 to 5. In addition, the battery 600 (e.g., the wireless battery management device of the battery 600) may communicate with a control system of the electric vehicle (e.g., an electronic control unit (ECU)) through a communication module (e.g., a wired communication network (e.g., a control area network (CAN))). The control system of the electric vehicle communicates with the wireless battery management device included in the battery 600 through the communication module, and may control the state of the battery 600.

Meanwhile, the case where the battery is included in the electric vehicle has been described above as an example. However, the battery of the present disclosure may be included in various devices utilizing the battery (hereinafter, “battery utilizing devices”). For example, the battery utilizing devices may include an electric mobility device (e.g., a hybrid vehicle, an electric bicycle, an electric motorcycle, etc.) which includes the battery, and is driven by the power of the battery. As another example, the battery utilizing devices may include an energy storage system (ESS) which includes the battery. Here, the energy storage system (ESS) may store a residual energy in the battery, use the energy stored in the battery for driving upon the shortage of electric power, or provide the stored energy to an external device (e.g., transmit the power to an external device).

The contents described above are merely an example of applying the principle of the present disclosure, and other configurations may be further included without departing from the scope of the present invention. For example, at least some of the various embodiments of the present disclosure described above may be combined.

What is claimed is:

1. A wireless battery management device, comprising:
a first battery management module located inside a first case which houses a plurality of battery modules, and configured to comprehensively manage the plurality of battery modules;
a first wireless communication chip located inside the first case, and connected to the first battery management module;
a plurality of second battery management modules respectively located inside a plurality of second cases formed including a metal material, each of which houses the plurality of battery modules, and configured to monitor and manage states of the plurality of battery modules, respectively; and
a plurality of second wireless communication chips respectively located inside the plurality of second cases, each of which is connected to the plurality of second battery management modules, and configured to communicate wirelessly with the first wireless communication chip,
wherein the plurality of second cases include first openings formed respectively at positions facing the plurality of second wireless communication chips.

2. The wireless battery management device according to claim 1, wherein the first case comprises:
a first region where the plurality of battery modules are located; and
a second region where a first substrate, on which the first battery management module and the first wireless communication chip are mounted, is located.

3. The wireless battery management device according to claim 1, wherein the first region and the second region are separated by a shielding film having a second opening formed on one side thereof.

4. The wireless battery management device according to claim 1, wherein the first case comprises:
a first region where some of the plurality of battery modules are located;
a second region where the remainder of the plurality of battery modules are located; and
a third region where a first substrate, on which the first battery management module and the first wireless communication chip are mounted, is located.

5. The wireless battery management device according to claim 1, wherein the first region, the second region, and the third region are separated from each other by shielding films, and
the shielding film has a second-1 opening formed between the first region and the third region, and a second-2 opening formed between the second region and the third region.

6. The wireless battery management device according to claim 1, wherein the first wireless communication chip is disposed at an end portion of the first substrate on which the first battery management module and the first wireless communication chip are mounted, and
the plurality of second wireless communication chips are respectively disposed at end portions of the plurality of second substrates.

7. The wireless battery management device according to claim 1, wherein the first wireless communication chip and the plurality of second wireless communication chips include antennas configured to transmit and receive wireless signals.

8. The wireless battery management device according to claim 1, further comprising an external communication chip configured to communicate with an external device operated by a power received from a battery pack including the wireless battery management device.

9. A battery pack, comprising:
a plurality of battery modules which comprise a plurality of battery cells, respectively;
a first case which houses the plurality of battery modules;
a first substrate which comprises a first battery management module located on one side of an inside of the first case and configured to comprehensively manage the plurality of battery modules, and a first wireless communication chip connected to the first battery management module;
a plurality of second substrates which comprise a second battery management module configured to monitor states of the plurality of battery cells, and a second wireless communication chip connected to the second battery management module and configured to communicate wirelessly with the first wireless communication chip, wherein the plurality of second substrates are included in the plurality of battery modules, respectively; and
a plurality of second case which house the plurality of battery cells and the plurality of second substrates, has at least one opening formed at a position facing the second wireless communication chip, and is formed including a metal material.

10. A device including a battery pack comprising:
a battery pack which comprises a wireless battery management device, comprising: a first battery management module located inside a first case which houses a plurality of battery modules, and configured to comprehensively manage the plurality of battery modules; a first wireless communication chip located inside the first case, and connected to the first battery management module; a plurality of second battery management modules respectively located inside a plurality of second cases formed including a metal material, each of which houses the plurality of battery modules, and configured to monitor and manage states of the plurality of battery modules, respectively; and a plurality of second wireless communication chips respectively located inside the plurality of second cases, each of which is connected to the plurality of second battery management modules, and configured to communicate wirelessly with the first wireless communication chip, wherein the plurality of second cases include first openings formed respectively at positions facing the plurality of second wireless communication chips;
a communication module configured to communicate with the wireless battery management device; and
a control system configured to communicate with the wireless battery management device through the communication module, and control a state of the battery pack.

11. The device according to claim 10, wherein the first case comprises
a first region where the plurality of battery modules are located; and
a second region where a first substrate, on which the first battery management module and the first wireless communication chip are mounted, is located.

12. The device according to claim 11, wherein the first region and the second region are separated by a shielding film having a second opening formed on one side thereof.

13. The device according to claim 10, wherein the first case comprises:
a first region where some of the plurality of battery modules are located;
a second region where the remainder of the plurality of battery modules are located; and
a third region where a first substrate, on which the first battery management module and the first wireless communication chip are mounted, is located.

14. The device according to claim 13, wherein the the first region, the second region, and the third region are separated from each other by shielding films, and
the shielding film has a second-1 opening formed between the first region and the third region, and a second-2 opening formed between the second region and the third region.

15. The device according to claim 10, wherein the first wireless communication chip is disposed at an end portion of the first substrate on which the first battery management module and the first wireless communication chip are mounted, and
the plurality of second wireless communication chips are respectively disposed at end portions of the plurality of second substrates.

16. The device according to claim 10, wherein the first wireless communication chip and the plurality of second wireless communication chips include antennas configured to transmit and receive wireless signals.
